(19) United States
(12) Patent Application Publication
(10) Pub. No.: US 2008/0139236 A1
(43) Pub. Date: Jun. 12, 2008

(54) Method and Apparatus For Transmitting Data

(75) Inventor: Stephen J. Barrett, Curridge (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/908,518

(22) PCT Filed: Mar. 6, 2006
(86) PCT No.: PCT/US2006/007763

§ 371 Date: Sep. 13, 2007

(30) Foreign Application Priority Data
Mar. 31, 2005 (GB) 0506538.8

(51) Int. Cl. H04B 7/00

(52) U.S. Cl. 455/522

(57) ABSTRACT

An apparatus, comprises an interface (113) receiving first data scheduled for a first set of channels by a remote scheduler (107). A local scheduler (111) allocates data for a second set of channels in response to a power usage assumption of the power used by the remote scheduler (107). A transmit power processor (117) determines a transmit power associated with the first data in a first time interval of a scheduling time interval of the local scheduler (111) and a power limiter (119) is arranged to limit a transmit power level of the first data in the scheduling time interval in response to the determined power resource. The resulting signal is transmitted to user equipment (123) by a transceiver (121). The invention may be particularly suitable for a 3^{rd} generation cellular communication system supporting High Speed Downlink Packet Access (HSDPA) services.

### FIELD OF THE INVENTION

The invention relates to a method and apparatus for transmitting data and in particular to transmit power management when transmitting data.

### BACKGROUND OF THE INVENTION

Currently, the most ubiquitous cellular communication system is the 2nd generation communication system known as the Global System for Mobile communication (GSM). Furthermore, 3rd generation systems have recently been rolled out to further enhance the communication services provided to mobile users. One such example is the Universal Mobile Telecommunication System (UMTS).

3rd generation cellular communication systems have been specified to provide a large number of different services including efficient packet data services. For example, downlink packet data services are supported within the 3^{rd} Generation Partnership Project 3GPP release 5 specifications in the form of the High Speed Downlink Packet Access (HSDPA) service.

HSDPA seeks to provide packet access services with a relatively low resource usage and with low latency. Specifically, HSDPA uses a number of techniques in order to reduce the resource required to communicate data and to increase the capacity of the communication system. These techniques include Adaptive Coding and Modulation (AMC), retransmission with soft combining and fast scheduling performed at the base station.

In HSDPA, transmission resources, such as codes and transmit power, are shared amongst users according to their traffic needs. The base station (also known as the Node-B for UMTS) is responsible for allocating and distributing the HSDPA transmission resources amongst the individual calls. In a UMTS system that supports HSDPA, some of the code and power allocation is performed by the Radio Network Controller (RNC) whereas other code and power allocation is performed by the base station by a local scheduling of data for transmission to HSDPA mobile stations. Specifically, the RNC typically assigns a given resource to each base station, which the base stations may individually allocate to different high speed packet services. The RNC furthermore controls the flow of data to and from the base stations. The individual base station is responsible for scheduling HS-DSCH (High Speed-Downlink Shared CHannel) transmissions to the mobile stations that are attached to it, for operating a retransmission scheme on the HS-DSCH channels, for controlling the coding and modulation for HS-DSCH transmissions to the mobile stations and for transmitting data packets to the mobile stations.

In order to reduce the resource usage for HSDPA channels, scheduling is thus performed at the base station rather than at the RNC. This allows scheduling to be sufficiently fast to dynamically follow radio condition variations. For example, when more than one mobile station requires resource from the shared HSDPA channel, the base station may schedule data to the mobile stations experiencing favourable radio conditions in preference to the mobile stations experiencing less favourable conditions. Furthermore, the allocated resources and the coding and modulation applied to transmissions to mobile stations may be highly tailored to the current radio conditions experienced by the individual mobile station. Thus, the fast scheduling performed at the base station allows link adaptation and an efficient resource usage.

However, although a distributed data scheduling/resource allocation may provide advantages, the approach also results in a number of problems and disadvantages.

For example, the data schedulers of the RNC and base stations are arranged to schedule data in order to achieve an efficient power resource allocation. However, the distributed approach and different timescales of the scheduling algorithms make this difficult and typically result in suboptimal performance.

Specifically, as the RNC is remote from the base station, the communication delays and backhaul bandwidth restrictions result in the scheduling timescales being significantly higher than for the base station scheduler.

Typically, a RNC has a limited set of load management algorithms that are activated in an event driven way, eg. when a new call is admitted admission control is run, when there is an overload then congestion control is invoked etc. Also, the RNC may periodically receive power measurements with an interval between measurement updates in the order of several 100 ms. The power measurements may be used for admission control and additionally calls may typically enter and leave the system at a frequency in the order of every few 100 ms. Accordingly, the RNC may typically have associated scheduling time scales in the order of 100 ms or longer.

Thus, the inputs to the scheduling algorithm are received at a relatively low rate and the scheduling intervals are relatively long. Accordingly, the RNC is only capable of controlling average power levels measured over relatively long timescales (e.g. in the order of around 100 ms or longer depending on e.g. the frequency of the transmit power measurement reporting). Also, the RNC is only capable of making power management actions/corrections through the action of admission control and RNC overload control. However, these functions are associated with long timescales (in the order seconds). Thus, the RNC's transmit power resource management is related only to relatively long timescale average transmit powers. However, the actual transmit power for the channels controlled by the RNC may fluctuate substantially from the average value due to the power control functionality adapting the transmit power to the variations in the propagation conditions at a much faster rate than the RNC scheduling time scales.

However, in contrast to the operation of the RNC, the base station scheduling may operate on much shorter timescales. For example, in UMTS, the base station HSDPA scheduling function manages power resource on a timescale of 2 ms. This allows data scheduling to take into account fast variations (such as fast fading) of the propagation conditions and results in a more efficient resource usage.

However, this mismatch in the timescales on which the RNC manages power relative to the timescale on which the base station manages power results in disadvantages. Specifically, the transmit power resource distribution between the RNC scheduler and the base station scheduler cannot be faster than the power management timescale of the RNC. However, as the actual transmitted power of the non-HSDPA channels scheduled by the RNC may vary substantially from the average power, the total transmit power may exceed the available transmit power and/or the base station HSDPA scheduler may not be able to utilise all the available transmit power resource.

As an example, the RNC cannot ensure that the power consumed by the RNC controlled (non-HSDPA) channels is less than some absolute amount when measured over a scheduling interval of the base station scheduler (e.g. over a 2 ms interval). This represents a problem for the HSDPA scheduler in the base station as it does not know how much power is available for transmission of the HSDPA signals scheduled by the base station scheduler.

As a consequence, the base station scheduler may assume that the available transmit power is lower than the actual available transmit power resulting in less data being scheduled than possible and thus resulting in an inefficient resource usage and reduced capacity. In contrast, if the base station scheduler assumes that there is more transmit power resource available than there actually is, the maximum total available transmit power may be exceeded. This may result in e.g. the output power amplifier being overloaded or driven into a non-linear operating area resulting in increased interference and reduced performance.

As a specific example, the excessive combined transmit power may result in excessive interference levels that may cause some links to hit maximum power constraints (such as the maximum power per code) resulting in packets being dropped. As another example, power amplifier saturation may occur (with the power amplifier entering a non-linear region) resulting in mobile stations not being able to decode signals correctly such that packets are lost.

Hence, an improved system for power management would be advantageous and in particular a system allowing increased flexibility, low complexity, facilitated scheduling and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus comprising: means for receiving first data scheduled for a first set of channels by a remote scheduler; a local scheduler arranged to allocate data for a second set of channels in response to a power usage assumption of the power used by the data scheduled by the remote scheduler; means for transmitting the first data in the first set of channels and the second data in the second set of channels; means for determining a transmit power associated with the first data in a first time interval of a scheduling time interval of the local scheduler; means for limiting a transmit power level of the first data in the scheduling time interval in response to the determined transmit power.

The invention may allow an efficient resource allocation using distributed schedulers. In particular, the invention may allow an improved use of a shared power resource for example by allowing the local scheduler to use a more aggressive scheduling criterion as the disadvantages of an excessive combined power may be mitigated. The invention may allow improved power overload control, mitigation and/or avoidance and/or may provide reduced interference. The invention may improve the performance of the communication of data in the first and/or second set of channels and may improve the performance of the communication system as a whole.

In particular, improved performance may be achieved for locally scheduled channels by allowing a local transmit power limitation for remote scheduled channels.

In some embodiments the transmit power limitation may be determined for a larger time interval than for the first time interval of a single scheduling time interval. Also, in some embodiments, the amount of limitation applied to the transmit power level of the first data in the scheduling time interval may be determined in response to the amount of power resource required by the local scheduler and/or the amount of power required by the remote scheduler. Thus, the power determination and/or transmit power limitation in the first time interval does not preclude power determination being made in response to transmit power requirements in other time intervals. Also, transmit power limiting in the first time interval of a scheduling time interval does not preclude applying the same power limitation in other time intervals.

According to an optional feature of the invention, the first time interval of the resource time interval has a duration substantially identical to a power control time interval duration. This may provide for improved performance and/or a practical implementation. In particular, the transmit power may be substantially constant within a power control time interval thereby allowing improved power overload management and/or mitigation.

According to an optional feature of the invention, the means for determining the transmit power is arranged to determine the transmit power associated with the first data by determining a total transmit power of a transmitted signal and subtracting a transmit power level associated with the second set of channels. This provides for an accurate and/or low complexity determination.

According to an optional feature of the invention, the means for limiting is arranged to limit the transmit power if the transmit power exceeds the power usage assumption. This may provide improved performance. In particular, it may provide a suitable determination of whether a higher than expected transmit power of the first set of channels occurs thereby allowing the effect thereof to be mitigated.

According to an optional feature of the invention, the means for limiting is arranged to limit the transmit power if the transmit power exceeds a power threshold. This provides an efficient yet low complexity power limitation.

According to an optional feature of the invention, the means for limiting the transmit power level is arranged to further limit the transmit power level of the first data in response to a power resource associated with the local scheduler.

In particular, improved performance may be achieved by allowing a local transmit power limitation for remote scheduled channels in response to locally scheduled channels. For example, the performance of the second set of channels may be improved by limiting a power allocated to the first set of channels if the local scheduler schedules data for the second set of channels resulting in excessive total power. E.g. if the total power increases such that a power amplifier is overloaded, the power for the first set of channels may be reduced thereby mitigating the overloading without impacting the locally scheduled channels.

According to an optional feature of the invention, the means for limiting is arranged to limit the transmit power if the transmit power is in a non-linear region of a power amplifier of the means for transmitting. This may improve performance and may in particular provide reduced distortion and/or interference.

According to an optional feature of the invention, the means for limiting is arranged to reduce a gain of a transmit path associated only with the first set of channels. The gain may for example be a gain of a critical transmit path of the first set of channels. The gain is specifically a gain which does not affect a gain or transmit power of the second set of channels. The feature may provide improved performance and a practical and low complexity implementation.

According to an optional feature of the invention, the means for limiting is arranged to ignore at least some power up commands. Specifically, the means for limiting may be arranged to ignore power up commands received at the base site for some or all of the first set of channels. This may provide improved performance and a practical implementation.

According to an optional feature of the invention, the apparatus further comprises means for determining the power usage assumption in response to a previous power usage of the remote scheduler. This may provide an efficient and practical determination of the power usage assumption.

According to an optional feature of the invention, the power usage assumption is a fixed power resource allocation for the remote scheduler. The invention may for example allow improved performance for a distributed scheduling system using fixed resource distribution between different schedulers. The fixed power resource allocation may be static or semi-static. Specifically, a fixed power resource allocation is not varied in response to scheduling in one scheduling interval.

According to an optional feature of the invention, the first set of channels comprises channels comprised in Release 99 of the UMTS Technical Specifications by the 3^{rd} Generation Partnership Project.

According to an optional feature of the invention, the second set of channels comprises HSDPA channels as defined in the UMTS Technical Specifications by the 3^{rd} Generation Partnership Project.

According to an optional feature of the invention, the remote scheduler is a scheduler of an RNC of a UMTS cellular communication system.

According to an optional feature of the invention, the local scheduler is an HSDPA scheduler of a base station.

The invention may provide improved and particularly advantageous performance for third generation cellular communication systems providing HSDPA services.

According to another aspect of the invention, there is provided a base station for a third Generation Cellular Communication System comprising an apparatus as described above.

According to another aspect of the invention, there is provided a method of transmitting data comprising: receiving first data scheduled for a first set of channels by a remote scheduler; scheduling data for a second set of channels in response to a power usage assumption of the power used by the data scheduled by the remote scheduler; transmitting the first data in the first set of channels and the second data in the second set of channels; determining a transmit power associated with the first data in a first time interval of a scheduling time interval associated with the second channels; and limiting a transmit power level of the first data in response to the determined power resource.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system in accordance with the prior art;

FIG. 2 illustrates a method of transmitting data in accordance with some embodiments of the invention; and

FIG. 3 illustrates an example of a transmit path in accordance with some embodiments of the invention.

### DETAILED DESCRIPTION OF EMBODIMENTS OF THE INVENTION

The following description focuses on embodiments of the invention applicable to a cellular communication system and in particular to an UMTS cellular communication system supporting HSDPA services. However, it will be appreciated that the invention is not limited to this application but may be applied to many other communication systems.

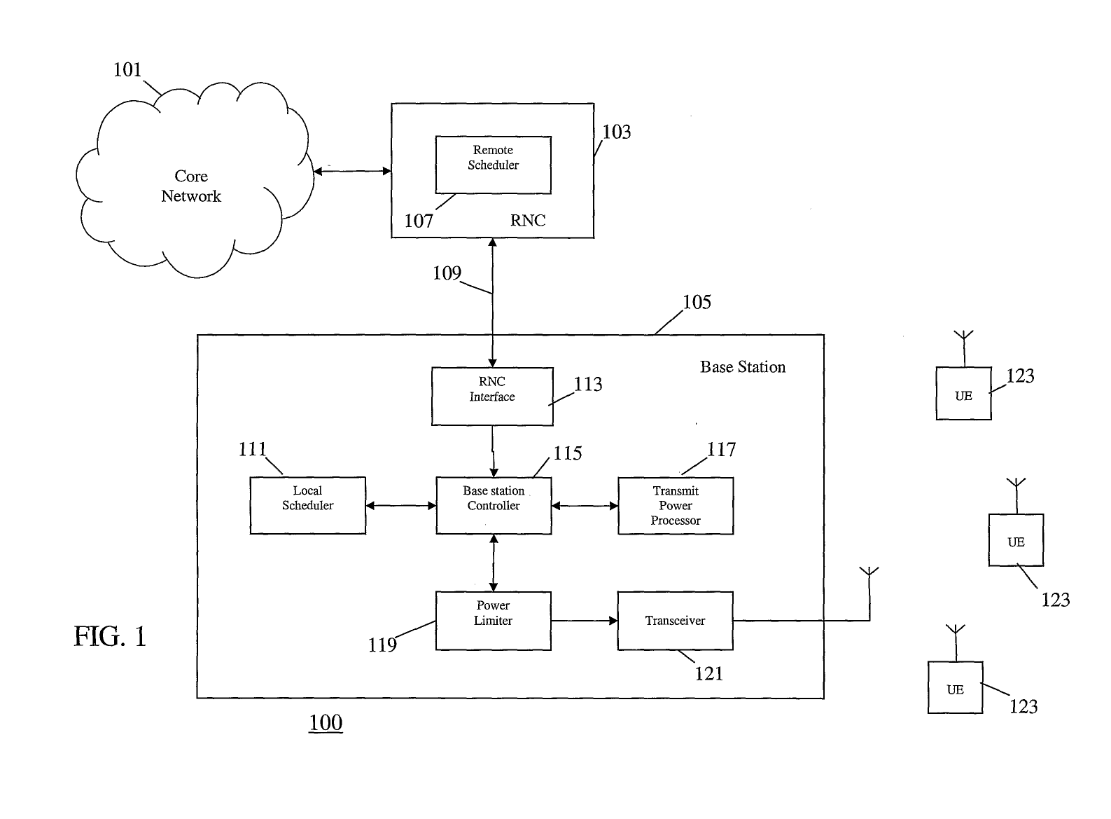

FIG. 1 illustrates a UMTS cellular communication system 100 in accordance with some embodiments of the invention.

The cellular communication system 100 comprises a core network 101 and a Radio Access Network (RAN). The core network 101 is operable to route data from one part of the RAN to another, as well as interfacing with other communication systems. In addition, it performs many of the operation and management functions of a cellular communication system, such as billing.

The RAN is operable to support wireless user equipment over a radio link being part of the air interface. A wireless user equipment may be e.g. a mobile station, a communication terminal, a personal digital assistant, a laptop computer, an embedded communication processor or any communication element communicating over the air interface. The RAN comprises the base stations, which in UMTS are known as Node Bs, as well as Radio Network Controllers (RNC) which control the Node Bs and the communication over the air interface.

For brevity and clarity FIG. 1 illustrates the core network 101 being coupled only to a single RNC 103 which itself is coupled to only one base station 105. The RNC 103 performs many of the control functions related to the air interface including some radio resource management and routing of data to and from appropriate base stations as will be known to the person skilled in the art. The base stations communicate with wireless user equipment over the radio air interface.

In the specific example, the communication system 100 is capable of supporting both traditional UMTS communication channels as defined in Release 99 of the UMTS Technical Specifications by the 3^{rd} Generation Partnership Project (henceforth referred to as R99 channels) as well as HSDPA communication channels as defined in Release 5 or later of the UMTS Technical Specifications by the 3rd Generation Partnership Project

Accordingly, the RNC 103 comprises a first data scheduler henceforth referred to as the RNC scheduler 107. The RNC scheduler 107 is responsible for scheduling data and thus allocating power resource for R99 channels. The RNC scheduler 107 allocates data for these channels on the basis of e.g. communication needs, a current cell loading and radio environment characteristics. However, as the RNC scheduler 107 is remote from the base station 105 and is connected to this through a backhaul connection known as an Iub interface 109, there is an inherent communication delay and desire to reduce the amount of signalling data communicated. Therefore, the RNC scheduler 107 uses a relatively long scheduling interval of typically around 100 msecs.

In a CDMA communication system, transmit power resource is typically a limiting factor (either as a direct transmit power limitation of a base station or through the created interference) and the RNC scheduler 107 allocates data in response to the transmit power. Specifically, the RNC scheduler 107 performs the power management based on average transmit powers where the average is measured over a relatively long time interval (typically several hundreds of milliseconds). However, the actual transmit power is controlled by the power control loop which may change the transmit power in 1 dB steps every 0.67 msec. Thus, the actual transmit power may vary substantially from the average transmit power within each 100 msec scheduling interval.

In accordance with the requirements for HSDPA, the base station 105 furthermore comprises an HSDPA scheduler for scheduling data for HSDPA channels, henceforth referred to as the base station scheduler 111. As the base station scheduler 111 is local to the base station 105, it may operate with a much shorter scheduling interval (in particular the scheduling may be in response to fast varying parameters determined in the base station 105 and the data to be scheduled is already queued at the base station 105 thus avoiding communication delays).

The fast scheduling at the base station 105 allows the base station scheduler 111 to schedule data for wireless user equipment in response to fast variations in the propagation conditions. Specifically, data may be scheduled for user equipment experiencing good current propagation conditions but not for user equipment currently experiencing poor propagation conditions.

Thus, the utilisation of data schedulers both local and remote to the base station allows advantageous performance. However, it is critical that power management is effectively performed in order to avoid degraded performance. For example, the scheduling of data by an HSDPA scheduler is frequently performed under the assumption of the RNC scheduler using the average transmit power in the scheduling interval of the RNC scheduler. However, as power control operation causes the actual transmit power for the R99 channels typically varying substantially from this value in a given HSDPA scheduling interval, the base station scheduler must either assume a very conservative average transmit power, resulting in the base station scheduler not being able to use all the available transmit power resource, and/or can assume a more realistic average transmit power value resulting in a frequent overload of the transmit power amplifier and thus increased distortion, interference and degraded performance.

A more efficient approach may be used in the example of FIG. 1.

The base station 105 comprises an RNC interface 113 which is operable to exchange data with the RNC 103 over the Iub interface 109. The RNC interface 113 is coupled to a base station controller 115 which is operable to control the operation of the base station 105.

The base station controller 115 is coupled to the base station scheduler 111 which schedules data for the HSDPA channels. The base station controller 115 is furthermore coupled to a transmit power processor 117 which is arranged to determine a transmit power associated with the data allocated by the RNC scheduler 107 in a first time interval of a scheduling time interval of the base station scheduler 111. Thus, a transmit power for the R99 channels in a given time interval within a scheduling frame may be determined. The determined transmit power may reflect the actual transmit power in this time interval rather than an average transmit power of an entire scheduling frame of the RNC scheduler 107. Thus, a more accurate indication of the actual transmit power in a time interval of a scheduling interval of the base station scheduler 111 is determined.

The time interval in which the transmit power of the R99 channels is determined may be an entire scheduling interval of the base station scheduler 111 or may be shorter than this. For example, in UMTS each HSDPA scheduling interval of 2 msec comprises three power control intervals of 0.67 msec. Thus, in some embodiments, the time interval may be a power control interval which may provide for a determination of a transmit power of the remotely scheduled channels which is constant within the determination interval. This may allow improved performance.

The base station controller 115 generates a signal for transmission by the base station 105 which comprises both the data scheduled by the base station scheduler 111 and the data scheduled by the RNC scheduler 107. This signal is fed to a power limiter 119.

The power limiter 119 is operable to limit a transmit power level in the scheduling time interval of the base station scheduler 111 in response to the transmit power for the data allocated by the RNC scheduler 107 and determined by the transmit power processor 117 within a time interval of that scheduling interval. Furthermore, the power limiter 119 is arranged not to limit the transmit power of the total combined signal but only of the data of the communication channels remotely scheduled by the RNC scheduler 107.

The power limiter 119 is coupled to a transceiver 121 which is operable to transmit the scheduled data over the radio interface to wireless user equipment 123 served by the base station 105.

Thus, in accordance with the described example, a base station may receive data scheduled for a first set of channels (R99 channels in the specific example) by a remote scheduler based on a long term average transmit power resource assumption. The base station may furthermore comprise a local scheduler which schedules data for a second set of channels (the HSDPA channels of the current example). The local scheduler may schedule this data using a power usage assumption of the power used by the data scheduled by the remote scheduler. In particular, the local scheduler may assume that the transmit power resource of the remote scheduler is equal to the average transmit power value.

In particular, the average transmit power value may not be a measured or calculated value but may be a power assignment or target for the schedulers. Specifically, a power resource may be distributed between the remote and the local scheduler by assigning a specific maximum transmit power to the remote scheduler and to the local scheduler. The remote schedulers may then schedule data until the average transmit power of a scheduling interval exceeds the assigned value. Similarly, the local scheduler may independently schedule data within a much shorter scheduling interval using the assigned transmit power allocation. Thus, the remote and local schedulers may effectively and independently schedule data using substantially different scheduling intervals.

Furthermore, disadvantageous effects of transmit power overloading may be mitigated by determining an actual transmit power indication of the data scheduled by the remote scheduler within one of the scheduling intervals of the local scheduler. Thus, if the power control operation of the channels of the remote scheduler result in an excessive short term transmit power exceeding that assumed when scheduling data by the local scheduler, this may be detected at the base station and may accordingly be limited to avoid overloading of the output power amplifier. Furthermore, the power limitation is performed on the channels which have been scheduled remotely thereby ensuring that the locally scheduled channels are not negatively affected by an instantaneous resource usage of the remote scheduler exceeding that assigned to it.

In some embodiments, the power limitation may only be in response to the determined transmit power for the remotely scheduled channels. For example, the power limiter 119 may be arranged to limit the transmit power if the transmit power of the remotely scheduled channels exceeds a power threshold. This power threshold may specifically be the power usage assumed by the local scheduler for the operation of the remote scheduler.

However, in other embodiments, the power limitation may also be in response to a power resource associated with the local scheduler. In particular, the power limiter 119 may determine the total current power for the data scheduled by the local scheduler in the current short scheduling interval and add the transmit power determined by the transmit power processor 117 for the data of the remote scheduler 107 within the time interval of the current short scheduling interval. In this example, the power limiter 119 may only limit the power of the channels of the remote scheduler if the total transmit power exceeds the available transmit power. This may allow that excess short term transmit power usage by the remote scheduler can be allowed if there is sufficient spare transmit power left over by the local scheduler.

Thus, a much more efficient transmit power resource utilisation may be achieved by the described example. Furthermore, an improved transmit power overload management may be achieved with a selective transmit power limitation. Thus, the impact of transmit power overload conditions may be mitigated.

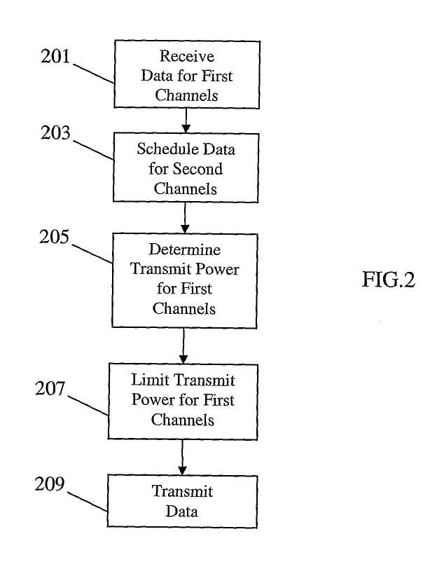

FIG. 2 illustrates a method of transmitting data in accordance with some embodiments of the invention. The method may be applied by the base station 105 of FIG. 1 and will partly be described with reference to this.

The method initiates in step 201 wherein first data is received for transmission in a first set of channels. The received data is scheduled for transmission by a remote scheduler using a first scheduling interval. In the example of FIG. 1 the RNC interface 113 may specifically receive data for transmission in R99 channels from the RNC scheduler 107.

Step 201 is followed by step 203 wherein a local scheduler schedules second data for a second set of channels using a different scheduling interval. The scheduling is performed using a power usage assumption of the power used by the data scheduled by the remote scheduler. Thus, an assumption of the amount of shared transmit power resource which is available to the local scheduler is used when scheduling. In the example of FIG. 1, the base station scheduler 111 may specifically schedule data for HSDPA channels using an assumed transmit power resource being available for HSDPA channels. The available transmit power resource is dependent on the average transmit power resource used by the RNC scheduler 107.

Step 203 is followed by step 205 wherein a transmit power associated with the first data in a first time interval of a scheduling time interval associated with the second channels is determined. At this stage the actual data scheduled to be transmitted in the first and second set of data channels respectively is known. Furthermore, the power control settings may be exactly or approximately known thereby allowing an accurate determination of the actual transmit power in the time interval to be determined.

Specifically, in the example of FIG. 1 the transmit power processor 117 may measure the total transmit carrier power in one of the slots making up the HSDPA 2 ms scheduling interval (or frame). The transmit power used by the data in the R99 channels may then be determined by subtracting the transmit power calculated by the locally scheduled HSDPA channels.

Step 205 is followed by step 207 wherein a transmit power level of the first data but not the second data is limited in response to the determined power resource. Specifically, if the actual transmit power level for the remotely scheduled data determined in step 205 exceeds a given level, the transmit power for the remotely scheduled channels are limited in step 207. Thus, in the example of FIG. 1, if the transmit power usage for the R99 channels exceeds an acceptable value, the transmit power of these channels is limited but without affecting the HSDPA channels.

It will be appreciated that any suitable criterion or algorithm for determining when or by how much to limit the transmit power may be used.

For example, the transmit power may be limited if the total combined transmit power for the first and second channels exceed a given available transmit power. In some embodiments, the transmit power may be limited if an output power amplifier enters a non-linear region as this may result in increased distortion and interference. For example, the power amplifier may be pre-characterized and a given transmit power level at which non-linearity is unacceptable may be defined and used as a threshold for determining when to limit the transmit power.

It will also be appreciated that any suitable means or approach for limiting the transmit power of the remotely scheduled data channels may be used. For example, the gain of a transmit path associated with the first communication channels but not the second communication channels may be reduced.

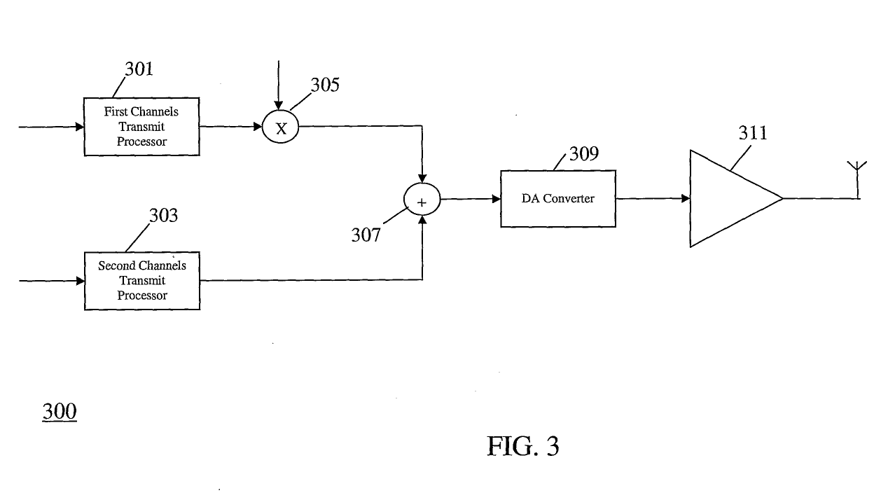

FIG. 3 illustrates an example of a transmit path 300 in accordance with some embodiments of the invention. The transmit path 300 comprises a first channels transmit processor 301 which receives the digital data for the remotely scheduled communication channels and which performs the digital transmit processing for the data including forward error coding, interleaving, channel symbol generation (pulse shaping), digital upconversion etc as is will be well known to the person skilled in the art. Similarly, the transmit path 300 comprises a second channels transmit processor 303 which receives the digital data for the locally scheduled communication channels and which performs the digital transmit processing for the data including forward error coding, interleaving, channel symbol generation (pulse shaping) etc as is will be well known to the person skilled in the art.

The first channels transmit processor 301 is coupled to a gain element 305 which adjusts the gain of the digital transmit path for the remotely scheduled data. The gain element 305 and the second channels transmit processor 303 are coupled to a combiner 307 which combines the data for transmission in the first and second signals into a single combined signal. The combiner 307 is coupled to a Digital-to-Analog converter 309 which converts the digital signal into an analog signal. The Digital-to-Analog converter 309 is coupled to a power amplifier 311 which amplifies the combined signal for transmission over the air interface (in most practical examples further up-conversion may occur in the analog domain such as between the Digital-to-Analog converter 309 and the power amplifier 311).

In the example of FIG. 3 the transmit power of the remotely scheduled channels may conveniently be limited by adjusting the gain of the gain element 305. This limitation will not affect the transmit power of the locally scheduled data.

In some embodiments, the transmit power limitation may be performed by ignoring at least some power up commands for some or all of the communication channels which are remotely scheduled. In the specific example, a proportion of the RNC-scheduled R99 channels may be forced to disregard any power up commands that they receive.

Step 207 is followed by step 209 wherein the first data is transmitted in the first set of channels and the second data is transmitted in the second set of channels. Thus, the base station 105 specifically transmits the data scheduled by the RNC scheduler 107 in the appropriate R99 channels and the data scheduled by the base station scheduler 111 in the appropriate HSDPA channels.

As described above, the invention may allow a pre-assigned average power allocation between two schedulers to be more efficiently used. A power usage assumption for the local scheduler may be a fixed power resource allocation of the remote scheduler. However, in other embodiments the power usage assumption may be dynamically varied at a suitable rate. For example, the power usage assumption may be determined in response to a previous power usage of the remote scheduler. As a specific example, the base station may at the end of each 100 msec R99 scheduling interval determine the actual average transmit power used by the R99 channels and use this value as the power usage assumption for the local scheduler in the following 100 msec interval.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus comprising:
means for receiving first data scheduled for a first set of channels by a remote scheduler
a local scheduler arranged to allocate data for a second set of channels in response to a power usage assumption of the power used by the data scheduled by the remote scheduler;
means for transmitting the first data in the first set of channels and the second data in the second set of channels;
means for determining a transmit power associated with the first data in a first time interval of a scheduling time interval of the local scheduler;
means for limiting a transmit power level of the first data in the scheduling time interval in response to the determined transmit power.

2. The apparatus claimed in claim 1 wherein the first time interval of the resource time interval has a duration substantially identical to a power control time interval duration.

3. The apparatus claimed in claim 1 wherein the means for determining the transmit power is arranged to determine the transmit power associated with the first data by determining a total transmit power of a transmitted signal and subtracting a transmit power level associated with the second set of channels.

4. The apparatus claimed in claim 1 wherein the means for limiting is arranged to limit the transmit power level if the transmit power exceeds one of the group of the power usage assumption and a power threshold.

5. The apparatus claimed in claim 1 wherein the means for limiting the transmit power level is arranged to further limit the transmit power level of the first data in response to a power resource associated with the local scheduler.

6. The apparatus claimed in claim 1 wherein the means for limiting is arranged to limit the transmit power if the transmit power is in a non-linear region of a power amplifier of the means for transmitting.

7. The apparatus claimed in claim 1 wherein the means for limiting is arranged to reduce a gain of a transmit path associated only with the first set of channels.

8. The apparatus claimed in claim 1 wherein the means for limiting is arranged to ignore at least some power up commands.

9. The apparatus claimed in claim 1 wherein the apparatus further comprises means for determining the power usage assumption in response to a previous power usage of the remote scheduler.

10. A method of transmitting data comprising:
receiving first data scheduled for a first set of channels by a remote scheduler,
scheduling data for a second set of channels in response to a power usage assumption of the power used by the data scheduled by the remote scheduler;
transmitting the first data in the first set of channels and the second data in the second set of channels;
determining a transmit power associated with the first data in a first time interval of a scheduling time interval associated with the second channels; and
limiting a transmit power level of the first data in response to the determined transmit power.
